(19) United States
(12) Patent Application Publication
(10) Pub. No.: US 2026/0131589 A1
(43) Pub. Date: May 14, 2026

(54) SYSTEMS AND METHODS FOR IMPLEMENTING A MICRO-SYMBOL-BASED SECURITY MARK

(71) Applicant: XEROX CORPORATION, NORWALK, CT (US)

(72) Inventors: Haripriya CHANDRAN, Kulathur (IN); Subhashree VIJAYARAGHAVAN, Coimbatore (IN); Arunkumaraan SHANMUGAMKRISHNAN, Surya Nagar (IN)

(73) Assignee: XEROX CORPORATION, NORWALK, CT (US)

(21) Appl. No.: 18/947,842

(22) Filed: Nov. 14, 2024

(51) Int. Cl. B41M 3/14

(52) U.S. Cl. CPC B41M 3/142

(57) ABSTRACT

The present disclosure describes methods and systems for implementing a security mark. The method includes receiving an input image and a predefined security label. Based on the received security label, a micro-symbol is selected and an output image is generated such that the selected micro-symbol is embedded in the output image. Further, the present disclosure describes methods and systems for controlling a preset task. The method includes receiving an input image including a micro-symbol. Thereafter, a principal character and a set of peripheral characters are determined in the microtext characters. Once determined, a color and an angle associated with the set of peripheral characters are compared with a color and an angle associated with pre-stored micro-symbols. Upon successful comparison, a security label associated with the micro-symbol is determined and accordingly, a preset task is inhibited for the input image.

### TECHNICAL FIELD

The present disclosure generally relates to image processing, and more particularly, to systems and methods for implementing a micro-symbol-based security mark.

### BACKGROUND

Security is crucial in document printing, especially for official, government, and financial applications such as event ticketing and cheque authentication. However, incorporating and decoding security marks in documents to prevent copying, forging, or counterfeiting generally comes with added complexity and costs. Whether visible or requiring specialized ambient conditions like infrared (IR) or ultraviolet light, the typical security marks often increase hardware implementation costs, operational time, and inconvenience for users. Additionally, security marks such as IR marks typically consume a significant space on a document, thereby limiting the available area on the document for other content or design elements and sometimes resulting in data loss or data degradation due to overlap with existing elements. Thus, there exists a need for improved solutions for the implementation of security marks that occupy an amount of space when printed on a document, aid in preventing data loss, and enhance user convenience while ensuring document authenticity.

### SUMMARY

According to aspects illustrated herein, a computer-implemented method for implementing a security mark is disclosed. The method includes receiving, using a processor, an input image of a document, wherein the input image includes a region that may not include content. The method also includes receiving, using the processor, a predefined security label for the input image. The method further includes selecting, using the processor, a micro-symbol based on the received security label, the micro-symbol including microtext characters having a principal character and a set of peripheral characters, wherein the set of peripheral characters has the same color along a set direction from the principal character. Additionally, the method includes generating, using the processor, an output image based on the selected micro-symbol. The output image includes the selected micro-symbol embedded in the region, wherein the micro-symbol represents a security mark pertaining to a preset task.

According to another aspect illustrated herein, a system for implementing a security mark is disclosed. The system includes an image source configured to provide an input image of a document. The system also includes a processor operating in communication with the image source, wherein the processor is configured to receive the input image, wherein the input image includes a region that may not include content. The processor is also configured to receive a predefined security label for the input image and select a micro-symbol based on the received security label. The micro-symbol includes microtext characters having a principal character and a set of peripheral characters, wherein the peripheral characters in the set has the same color along a set direction from the principal character. Further, the processor is configured to generate an output image based on the selected micro-symbol. The output image includes the selected micro-symbol embedded in the region, wherein the micro-symbol represents a security mark pertaining to a preset task.

According to yet another aspect illustrated herein, a computer-implemented method for configuring an image processing unit to control a preset task is disclosed. The computer-implemented method includes receiving, using a processor, an input image including a micro-symbol representing a security mark, wherein the micro-symbol includes microtext characters defining a shape of the micro-symbol. The method also includes determining, using the processor, a principal character in the microtext characters and determining a set of peripheral characters in the microtext characters based on the principal character. The set is determined based on the peripheral characters therein having the same color along a fixed direction from the principal character, wherein the fixed direction corresponds to a set angle with respect to a horizontal axis. The method further includes comparing the color and the angle associated with the set of peripheral characters with a color and an angle associated with one or more pre-stored micro-symbols and upon successful comparison, determining, using the processor, a security label associated with the micro-symbol. Additionally, the method includes inhibiting, using the processor, a preset task for the input image based on the determined security label.

According to yet another aspect illustrated herein, a system for configuring an image processing device to control a preset task is disclosed. The system includes an image source configured to provide an input image including a micro-symbol representing a security mark, wherein the micro-symbol further includes microtext characters defining a shape of the micro-symbol. The system also includes a processor operating in communication with the image source, wherein the processor is configured to receive the input image including the micro-symbol. The processor is also configured to determine a principal character in the microtext characters of the micro-symbol and to determine a set of peripheral characters in the microtext characters based on the principal character. The set is determined based on the peripheral characters therein having the same color along a fixed direction from the principal character, wherein the fixed direction corresponds to a set angle with respect to a horizontal axis. Further, the processor is configured to compare the color and the angle associated with the set of peripheral characters with a color and an angle associated with one or more pre-stored micro-symbols, and upon successful comparison, to determine a security label associated with the micro-symbol. Additionally, the processor is configured to inhibit a preset task for the input image based on the determined security label.

Other and further aspects and features of the present disclosure will be evident from reading the following detailed description of the embodiments, which are intended to illustrate, not limit, the present disclosure.

### BRIEF DESCRIPTION OF THE DRAWINGS

The illustrated embodiments of the present disclosure will be best understood by reference to the drawings, wherein like parts are designated by like numerals throughout. The following description is intended only by way of example, and simply illustrates embodiments of devices, systems, and methods that are in accordance with the subject matter as claimed herein.

FIG. 1 is a schematic of a system for implementing a micro-symbol-based security mark (MSSM) module, according to embodiments of the present disclosure;

FIG. 2 is a flowchart illustrating a method implemented by the MSSM module of FIG. 1 to print a micro-symbol-based security mark on a print medium, according to embodiments of the present disclosure;

FIGS. 3A-3B illustrate a first micro-symbol and a second micro-symbol respectively implemented by the MSSM module of FIG. 1, according to embodiments of the present disclosure;

FIGS. 4A-4B are flowcharts illustrating a method implemented by the MSSM module of FIG. 1 to verify and validate a micro-symbol, according to embodiments of the present disclosure;

FIG. 5 illustrates a document including the first micro-symbol of FIG. 3A, according to embodiments of the present disclosure; and

FIG. 6A-6D illustrate snapshots, in accordance with embodiments of the present disclosure.

### DESCRIPTION

The following detailed description is provided with reference to the drawings herein. Configurations are provided as examples so as to enable those skilled in the art to practice the subject matter. It will be appreciated that further variations of concepts and configurations disclosed herein can be contemplated. The examples described in the present disclosure may be used together in different combinations. In the description herein, details are set forth in order to provide an understanding of the present disclosure. It will be readily apparent that the present disclosure may be practiced without limitation to all these details in some configurations. The terms “a” and “an” denote at least one of a particular element. The terms “a” and “an” may also denote more than one of a particular element. The term “includes” means includes but not limited to, the term “including” means including but not limited to. The term “based on” means based at least in part on, the term “based upon” means based at least in part upon, and the term “such as” means such as but not limited to. The term “approximately” or “about” means +/−x % of the stated number or an expected value, where x is context-dependent. The term “substantially” means +/−x % deviation from an expected value or a target value of an associated parameter, where x is context-dependent.

Definitions of one or more terms that are used in the present disclosure are described below without limitations. For a person skilled in the art, it would be understood that the definitions are provided for the sake of clarity, and include more examples than provided herein.

The terms “multi-function device” and “multi-functional device” are used interchangeably in the present disclosure in the context of their broadest definition. The multi-function device may refer to a computing device that incorporates one or more functions including printing, scanning, copying, emailing, archiving, and/or faxing in a single device. The multi-function device may perform and/or facilitate these functions as a service to network devices operably connected thereto. The multi-function device may operate as a standalone device or as a peripheral device to network devices. Further, the term includes stand-alone scanning devices, such as scanners which can scan the document.

The terms “media,” “medium,” “print media,” and “print medium” are used interchangeably in the present disclosure in the context of their broadest definitions. A print medium may refer to a physical substrate on which an image can be printed. Examples of the print medium may include paper, plastic or polymer, cardboard, and metals.

The term “document” is used in the present disclosure in the context of its broadest definition. A document may refer to an electronic document including a single page or multiple pages, unless specified otherwise. A document may represent or include a computer-readable file.

The term “user” is used in the present disclosure in the context of its broadest definition. A user may refer to a human, an artificial intelligence unit, or a combination thereof. A user may be capable of providing, receiving, or processing an input (e.g., data or command, media, electronic images, etc.) to perform or facilitate one or more tasks.

The terms “image,” “electronic image,” and “digital image” are used interchangeably in the present disclosure in the context of their broadest definition. An image may refer to a visual representation of electronic data such as raster objects, graphics objects, text, voice, and metadata (e.g., digital signatures, computer instructions, file path, user information, etc.) or any combinations thereof. In some configurations, the image may embed another image.

The term “workflow” is used in the present disclosure in the context of its broadest definition. A workflow may refer to a set of one or more tasks performed by a computing device independently or in communication with the user.

The term “image source” is used in the present disclosure in the context of its broadest definition. An image source may refer to a hardware or software entity configurable to read or capture the digital image and related data. An image source may include an optical scanner, camera, or any other suitable image capture terminal. In some configurations, an image source may represent or include a computing device and/or a sensor device. A sensor device may include an independent sensor, a sensor array, a computing device including a sensor, a sensor device array, or combinations thereof.

The terms “printer,” “print device,” and “image forming device” are used interchangeably in the present disclosure in the context of their broadest definitions. A printer may encompass an apparatus configurable to render an image on a print medium. A printer may include a multi-function device, a digital copier, a bookmaking machine, and a facsimile machine.

The term “microtext” is used in the present disclosure in the context of its broadest definition. Microtext may refer to a set of one or more characters having a size that is so small that individual characters are not typically discernable by the human eye. In some configurations, microtext may have a size threshold such as 1 point, 1/20th of an inch (2.54 cm), 1/50th of an inch, 1/100th of an inch, or the like, where 1 point may be equivalent to 1/72 inches, i.e., 0.0353 cm. In some configurations, fonts ranging from 0.72 point font to 1.08 point font may be considered microtext. In some configurations, microtext may have a size corresponding to 350 line pairs per degree or fewer. Other configurations may include a size threshold being less than 3 points (or 0.106 cm). In some configurations, microtext may include English characters and non-English characters, such as Chinese, Japanese, Hebrew or Arabic, which may have relatively larger sizes. Microtext may include natural language characters, symbols, or any other graphical elements.

The term “micro-symbol” is used in the present disclosure in the context of its broadest definition. Micro-symbol may refer to a printable symbol made up of a group of microtext characters forming a predefined shape. In some configurations, the micro-symbol may have a size up to 25 times of the microtext character contained therein. Other configurations may include the micro-symbol having a size up to 50 times the microtext character contained therein.

The term “principal character” is used in the present disclosure in the context of its broadest definition. A principal character may refer to a microtext character with respect to which other characters may be arranged within a micro-symbol. A principal character may be located at a geometric center of a micro-symbol or a portion thereof.

The term “peripheral character” is used in the present disclosure in the context of its broadest definition. A peripheral character may refer to a microtext character within a preset distance of (or at a preset angle from) the principal character.

The term “security mark” is used in the present disclosure in the context of its broadest definition. A security mark may refer to any visual or machine readable indicator on the image or the print medium, where such indicator conveys an intended meaning to the user. A security mark may include a graphical element (e.g., logo, symbol, etc.), a non-graphical element (e.g., microtext, string, number, etc.), or a combination thereof. In some configurations, a security mark may represent or include an image.

The references in the present disclosure to a micro-symbol-based security mark (MSSM) module are intended to cover devices capable of performing respective operations on electronic images in a standalone device or a networked device environment.

Various embodiments of the present disclosure describe devices, systems, and methods for implementation of a micro-symbol-based security mark in images such as electronic images. The configurations herein provide an approach to secure and classify documents. The configurations include methods, systems, and devices configured to create or implement a micro-symbol using microtext characters, where the micro-symbol or the microtext may have one or more predefined attributes such as shape, color, and size. The micro-symbol is used to classify a sensitive document. The sensitive documents may be classified based on a preset security label (e.g., confidential, restricted, etc.) associated with the micsarro-symbol. A micro-symbol may be associated with a security label. The micro-symbol is printed on a predefined or dynamically defined location on a hardcopy or print medium. The micro-symbol includes a principal character and a set of peripheral characters collectively forming a shape of the micro-symbol. The principal character may be located at a geometric center of the micro-symbol or a portion thereof. The principal character has attributes that may be the same or different from the set of peripheral characters. For example, the principal character may be red in color with the peripheral characters in CMYK (Cyan, Magenta, Yellow, Black) pure colors arranged in a sequential manner within the micro-symbol. Based on the security label, the set may include one or more peripheral characters having the same predefined color when located along the same predefined direction relative to the principal character in the micro-symbol.

During scanning, in order to verify the authenticity of the micro-symbol or a document embedded with the micro-symbol, the presence of known colored components (e.g., peripheral characters) of the micro-symbol along a known direction is checked. For further verification, the micro-symbol is binarized and subjected to a pixel reconstruction for validation. The document including the micro-symbol is classified using the associated security label based on one or more features (e.g., the principal character and attributes thereof including color and shape) embedded therein. Based on the security label, a predefined or dynamically defined task may be performed. Moreover, in some examples, the created micro-symbol may be also visualized and validated, e.g., by a user, using a magnifying glass.

The micro-symbol-based security mark created using microtext may be used as an alternative to an IR Mark. In some configurations, the micro-symbol may be created inside or with an IR mark to assist in classifying the document and initiate an intended action or task. The micro-symbol may classify documents based on a type of preset security label associated therewith. The micro-symbol-based security mark may enable one or more preset actions associated with the preset security label, or preset label type (e.g., numeric, alphabetical, alphanumeric, English language characters, non-English characters, etc.).

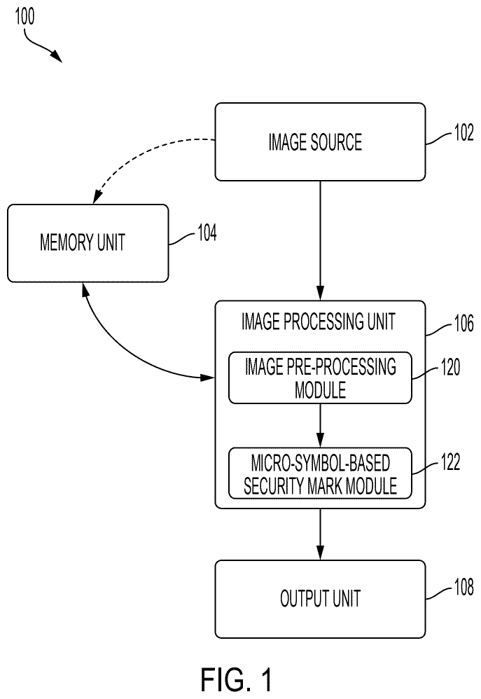

FIG. 1 shows a system 100 in which various embodiments of the disclosure can be practiced. The system 100 includes an image source 102, for example, but not limitedto, a multi-function device, that provides one or more functionalities such as printing, scanning, imaging, and so on. The system 100 may include scanners, printers, or any devices with scanning/printing functionalities. The image source 102 adds one or more micro-symbol-based security mark in an input image or a document. Specifically, the image source 102 adds the micro-symbol-based security mark on one or more pre-defined locations in the input image/document.

In operation, an input image is submitted at the image source 102 for adding the micro-symbol. The input image can be in a physical form, such as printed on paper, or can be in a digital form. The digital form/version can be submitted from a computing device (not shown) and the physical form/version can be submitted directly at the image source 102. In case of a physical form, the input image is scanned and a digital version is obtained. Information related to the location in the input image where the micro-symbol is to be added and the security label of the micro-symbol to be added are obtained. In some configurations, information related to the location and security label may be input by the user. In some configurations, the information related to the location and security label may be pre-defined depending upon various factors such as a user submitting the document, type of document or print media used, department of the user, and the like. Based on the security label, a micro-symbol that is, for example, but not limited to, stored in the image source 102 or stored in a remote database is retrieved. The image source 102 adds the retrieved micro-symbol to the input image based on the location information and generates an output image including the micro-symbol. In some configurations, the image source 102 displays the output image and the output image can be printed, forwarded, saved, and the like.

The image source 102 can verify and validate one or more micro-symbols embedded in an input image or document. In some configurations, an input image is submitted, including a micro-symbol, at the image source 102. The input image can be in a physical form or can be in a digital form. The digital form/version may be submitted from a computing device (not shown) and the physical form/version may be submitted directly at the image source 102. In case of a physical form, the input image is scanned and a digital version is obtained. A micro-symbol is located in the input image. In some configurations, the micro-symbol may be embedded at one or more locations in the input image. the image source 102 processes the one or more locations in the input image and locates the micro-symbol. The image source 102 determines/detects a principal character and a set of peripheral characters. The image source 102 determines the color associated with the set of peripheral characters and an angle that the set of peripheral characters makes with a horizontal axis. The image source 102 compares the determined color and the angle associated with the set of peripheral characters of the micro-symbol with known color and the angle associated with pre-stored micro-symbols. Upon successful match, the image source 102 validates the shape of the micro-symbol and based on the validation, the image source 102 performs a task. For example, when the shape of the micro-symbol is validated, the image source 102 determines a security label associated with the micro-symbol, which further assists in determining the one or more tasks such as, for example, but not limited to, sending an alert message to one or more intended parties.

A system 100 implements a micro-symbol-based security mark (MSSM) module, according to embodiments of the present disclosure. Configurations are discussed in the context of print workflows and scan workflows for implementing and decoding a security mark respectively on or from a print medium, such as a paper sheet. In general, configurations may be implemented in image processing and/or image production environments that include a computing device operating as a standalone device or in communication with network devices to implement or validate a security mark.

The configuration of FIG. 1 includes the system 100 which includes an image source 102, a memory unit 104, an image processing unit 106, and an output unit 108. The image source 102 may be configured to provide or generate an electronic image in a predefined color space. For example, the image source 102 may generate an electronic image (or input image) in RGB (Red, Green, Blue) color space. Other examples of the color space include CMYK (Cyan, Magenta, Yellow, Key or Black), HSL (Hue, Saturation, Lightness), YUV (where Y is luminance and UV is chrominance), and YCrCb (where Y is the luminance component, and Cb and Cr are the blue-difference and red-difference chroma components). In some configurations, the image source 102 may generate the input image in grayscale (or monochrome color space). The image source 102 may refer to a hardware or a software entity configurable to read or capture an electronic image and related data. The image source 102 may be produced by, for example, but not limited to, an optical scanner, camera, a sensor device, and/or other image acquisition device. In some configurations, the image source 102 may represent or include a computing device configured to receive and/or provide an input image. The computing device may include a multi-function device, such as image source 102, a mobile phone, a server, a laptop, and an internet appliance.

The image source 102 may communicate a captured image or a generated image to one or more connected devices over a network (not shown). The network may include the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. A network may include multiple networks or sub-networks, which may include, for example, a wired or wireless data pathway. A network may include a circuit-switched voice network, a packet-switched data network, or other network able to carry electronic communications. For example, the network may include networks based on the Internet protocol (IP) or asynchronous transfer mode (ATM), and may support voice using, for example, voice over IP (VoIP), voice-over-ATM, or other protocols used for voice, video, and data communications. As shown in FIG. 1, the image source 102 may communicate the input image to the memory unit 104 over the network. In some configuration, the input image is sent to the image processing unit 106 over the network. The image source 102 may receive an input image from a remote device to store or send to a network device, for example, such as the memory unit 104 and the image processing unit 106.

The memory unit 104 may receive or store an electronic image such as the input image for future access and/or retrieval by a network device such as the image processing unit 106. The memory unit 104 may include a non-transitory computer-readable medium, volatile memory (e.g., RAM), non-volatile memory (e.g., flash memory), a disk drive, etc., or combinations thereof. In some configurations, the memory unit 104 may receive the electronic image from a storage media (e.g., a compact disk, a flash drive, a memory card, etc.) via interfaces known in the art. In some configurations, the memory unit 104 may be integrated with the image source 102. In some configurations, the memory unit 104 may store a micro-symbol database including one or more predefined micro-symbols and attributes related thereto. Examples of the attributes may include microtext, size, color, shape, and a security label. The microtext may include one or more predefined characters in any predefined natural language such as English, Chinese, Japanese, Hebrew, and Arabic. The micro-symbol database, in some configurations, may include (1) one or more predetermined micro-symbols and known colors of microtext characters in the micro-symbols, (2) shapes of the micro-symbols, (3) sizes of the micro-symbols as well as sizes of the individual microtext characters in the micro-symbols, (4) a principal character and peripheral characters, (5) color of the principal character and peripheral characters, (6) color of a set of the peripheral characters where the set of peripheral characters have a uniform color along a direction and known angle that the set of the peripheral characters form with the horizontal axis, (7) security labels and the micro-symbols associated therewith, where the security label may be associated with the shape of the micro-symbol, combinations of colors and angles (of the set of the peripheral characters) in the corresponding micro-symbol, and (8) one or more tasks associated with the security labels. In some configurations, the memory unit 104 may store image data such as values of image pixels (e.g., color values, intensity values, lightness values, etc.) in one or more variables independently or in association with a kernel for use by the image processing unit 106. The memory unit 104 may operate in communication with the image processing unit 106 over the network.

The image processing unit 106 may represent a type of computing device including a processor (not shown) operable to configure one or more modules to implement the methods and underlying concepts disclosed herein. The image processing unit 106 may be implemented as a network device. In some configurations, the image processing unit 106 may be implemented as a standalone and dedicated device including hardware and installed software. In some configurations, aspects of the image processing unit 106 may be implemented as a software application or a device driver. In some configurations, the image processing unit 106 may be configured to expose its computing environment or operating code, and may include I/O devices, such as, for example, but not limited to, a keyboard and/or a display unit. In some configurations, the image processing unit 106 includes software, firmware, or other resources that support remote administration and/or maintenance of the image processing unit 106. The image processing unit 106 either independently or in communication with other network devices may also have video, voice, and data communication capabilities (e.g., unified communication capabilities). In some configurations, the image processing unit 106 may be integrated with or removably coupled to the image source 102, the memory unit 104, the output unit 108, audio devices (e.g., microphones, music players, recorders, speakers, telephones, etc.), video devices (e.g., monitors, projectors, cameras, interactive display units, digital video recorders, etc.), a multi-function device, printers and/or scanners or other types of hardware, in combinations thereof. In some configurations, the image processing unit 106 may include or implement one or more real-time protocols (e.g., session initiation protocol (SIP), H.261, H.263, H.264, H.323, etc.) and non-real-time protocols to facilitate data transfer (e.g., electronic images, micro-symbol and related data, micro-symbol database, etc.) to or from network devices including the image source 102, the memory unit 104, and the output unit 108.

In some configurations, the image processing unit 106 may be configured to (i) create, store, access, and/or implement a security mark based on a predefined micro-symbol associated with a preset security label using the micro-symbol database, (ii) implement the micro-symbol-based security mark on an electronic image and/or a print medium, (iii) verify the micro-symbol and/or the security label associated therewith using the micro-symbol database, (iv) validate the micro-symbol or the security label associated therewith, and (v) send a command or initiate (or inhibit) a preset task based on the security label. As illustrated in FIG. 1, the image processing unit 106 may include an image pre-processing module 120 and a micro-symbol-based security mark (MSSM) module 122.

The image pre-processing module 120 (or the processor) may receive or fetch the input image and associated data from the memory unit 104. The image pre-processing module 120 can receive the input image directly from the image source 102 such as an optical scanner. In some configurations, the image pre-processing module 120 (or the processor) may be configured to determine a color space of the input image. If the input image contains a single color channel (i.e., single value per pixel) with pixel values ranging from 0 to 255, the image pre-processing module 120 may conclude that the input image is received in grayscale or black and white (BW) color space (also referred to as monochrome color space). The input image may include three color channels with pixel values ranging from negative (−) 127 to positive 128 (also referred to as RGB range). Based on the input image having three values per pixel (typically representing Red, Green, and Blue) and the related pixel values, the image pre-processing module 120 may conclude that the input image is encoded in the RGB color space. In some embodiments, the image pre-processing module 120 may convert the input image in a first color space (e.g., RGB) to a different color space (e.g., monochrome, CIELAB, HSL, YUV, YCrCb, etc.).

The image pre-processing module 120 may transmit the converted image to the MSSM module 122 or the memory unit 104 for storage. In some configurations, the image pre-processing module 120 may transmit the input image from the image source 102 (or the memory unit 104) to the MSSM module 122. The image pre-processing module 120 may be configured to assist in converting communications (e.g., instructions, queries, data, etc.) from the one or more connected devices (such as the memory unit 104 and the output unit 108) into appropriate formats to make them compatible with the MSSM module 122, or vice versa.

The MSSM module 122 receives an electronic image such as the input image and related data from the image pre-processing module 120. In some configurations, the MSSM module 122 may fetch the input image and related data directly from the memory unit 104. The MSSM module 122 may be implemented by way of a device (e.g., a computing device, a processor or an electronic storage device) or a combination of devices that are operatively connected or networked together in the same location or different locations. In some configurations, the MSSM module 122 may be a hardware device including one or more processors such as the processor executing machine-readable program instructions for analyzing data, and interactions between the MSSM module 122 (or the image pre-processing module 120) and the output unit 108. The “hardware” may include a combination of discrete components, an integrated circuit, an application-specific integrated circuit (ASIC), a field programmable gate array (FPGA), a digital signal processor, or other hardware. The “software” may include one or more objects, agents, threads, lines of code, subroutines, separate software applications, two or more lines of code or other suitable software structures operating in one or more software applications or on one or more processors. The processors (not shown) may include, for example, microprocessors, microcomputers, microcontrollers, digital signal processors, central processing units, state machines, logic circuits, and/or any devices that can manipulate signals based on operational instructions. Among other capabilities, the processors may be configured to fetch and execute computer-readable instructions in a dedicated or shared memory associated with the MSSM module 122 for performing tasks such as signal coding, data processing input/output processing, power control, and/or other functions.

In some configurations, the MSSM module 122 may include a software application working alone without any additional hardware resources such as preprogrammed ASIC or FPGA to provide hardware acceleration. Such software applications may be executed by the processors on a hardware platform, or emulated in a virtual environment. Some aspects of the MSSM module 122 may leverage known, related art, or later developed off-the-shelf software. Other embodiments may include the MSSM module 122 being integrated or operating in communication with a mobile switching center, network gateway system, Internet access node, application server, IMS core, service node, or some other communication systems, including any combinations thereof. In some embodiments, the MSSM module 122 may be integrated with or implemented as a wearable device including, but not limited to, a fashion accessory (e.g., wrist band, ring, lanyard, watch, etc.), a utility device (e.g., access card, mobile robot, beacon, sensor device, etc.), a body clothing, or combinations thereof.

The MSSM module 122 either independently or in connection with the image processing unit 106 may include software interfaces (e.g., an application programming interface, a graphical user interface, etc.), hardware interfaces (e.g., cable connectors, a keyboard, a card reader, a barcode reader, a biometric scanner, an interactive display screen, etc.), or both. In some configurations, the MSSM module 122 may be preconfigured or dynamically configured to perform functions of the image pre-processing module 120, the image source 102, the memory unit 104, and the output unit 108. In some configurations, the MSSM module 122 may be preconfigured or dynamically configured to control the image pre-processing module 120, in addition to the memory unit 104 and the output unit 108, via a server (not shown) over the network. The server may be installed, integrated, or operatively associated with the MSSM module 122. The server may be implemented as a computing device including, for example, a general-purpose computing device, multiple networked servers (arranged in clusters or as a server farm), a mainframe, or so forth.

In some configurations, the MSSM module 122 is installed or integrated with a network appliance (not shown) configured to establish the network, e.g., between the MSSM module 122 and other devices such as the memory unit 104 and the output unit 108. At least one of the MSSM module 122 and the network appliance may be capable of providing an interface to assist in exchange of software instructions and data between the memory unit 104, modules of the image processing unit 106, and the output unit 108. In some configurations, the network appliance may be preconfigured or dynamically configured to include the MSSM module 122 integrated with other devices. For example, the MSSM module 122 may be integrated with the image source 102 or any other device connected to the network. The image source 102 may include a module (not shown), which may enable the MSSM module 122 for being introduced to the network appliance, thereby enabling the network appliance to invoke the MSSM module 122 as a service. The network appliance may include, but is not limited to including, a modem, a wireless access point, a router, a base station, and a gateway.

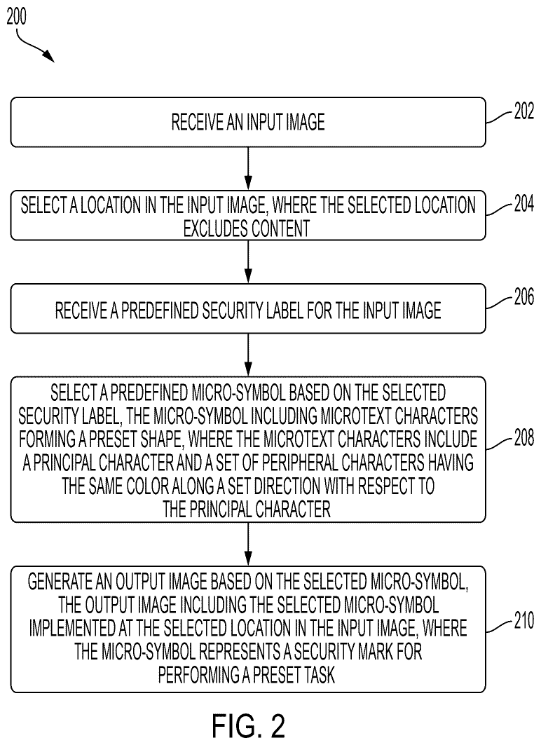

In some configurations, the MSSM module 122 may be configured to implement a method in accordance with embodiments of the present disclosure, such as, but not limited to, the method 200 of FIG. 2 to print a micro-symbol-based security mark on a print medium. The order of the steps in the method 200 is not intended to be construed as a limitation, and the method blocks may be combined or otherwise performed in any order to implement the method 200, or an alternate method. Individual blocks may be deleted from the method 200 without departing from the concepts described herein. The method 200 may be implemented in hardware, software, firmware, or combination thereof. The method 200 describes an implementation of the image processing unit 106 or modules thereof such as the MSSM module 122. In some configurations, the method 200 may be implemented by a remote device such as the output unit 108. In some configurations, the method 200 may be implemented by an image source 102, such as a multi-function device. The method 200 may be modified for implementation with configurations and methods or by the modules of the image processing unit 106 without departing from the concepts described in the present disclosure.

At 202, an input image is received. In some configurations, the MSSM module 122 receives an input image from the image pre-processing module 120. The input image may be received in a color space, for example, but not limited to, grayscale, RGB, and CMYK. The input image may have a color such as white (blank image). In some configurations, the input image may have content on a white background. The input image may have content in a monochrome color space. In some configurations, the MSSM module 122 receives or fetches the input image from the memory unit 104 or the image source 102. In some configurations, an input image may be generated by the MSSM module 122.

At 204, a location in the input image is selected. In some configurations, the MSSM module 122 may be configured to receive a user input to select or set a location in the input image. The user input may be received via an input device such as a keyboard (or a remote device) operably connected to the MSSM module 122 or the image processing unit 106. The location may correspond to a region, or a portion, in the input image (or a print medium), where the region may not include content. In some configurations, the location (or the region) may include a corner or an edge of the input image (or the print medium). In some configurations, the location (or the region) may include an imaginary symbol axis passing through a portion of the input image (or the print medium). The symbol axis may include a central axis, or a lateral axis of the input image. The symbol axis, in some configurations, may be limited to an upper portion, a lower portion, or a lateral portion of the input image (or the print medium). In some configurations, the symbol axis passes through the selected location (or the region) in the input image (or the print medium). In some configurations, the location (or region) may be selected from a set of predetermined regions (e.g., corner regions) in the input image (or the print medium), possibly based on the user input. In some configurations, the location (or the region) may be preselected or dynamically selected based on a variety of input factors. Examples of these input factors may include (i) a size or a type of the print medium (or the input image), (ii) an available area of a background region of the input image (or the print medium) or attributes thereof such as the background region set to a specific color such as white color, (iii) a user type (e.g., a work designation or role of a user in a preference hierarchy, an industry or domain, etc.), (iv) a user identifier (ID) or a user geographical location providing the user input, and (v) a device ID or a device geographical location of hardware from which the user input may be received by the MSSM module 122. The selected location or region in the input image may be stored in the memory unit 104 by the MSSM module 122.

At 206, a security label is received for the input image. In some configurations, the MSSM module 122 is configured to receive a user input to select a security label for the input image (or a print medium). The user input may be received via the input device. The security label may operate as a tag, which may indicate to the MSSM module 122 a preset task or an access level to be applied to or for the input image (or the print medium). Examples of the security label may include “CONFIDENTIAL”, “RESTRICTED”, “GENERAL”, “TOP SECRET”, “PRIVATE”, and so on. In some configurations, the MSSM module 122 may preselect or dynamically select the security label based on a variety of security factors. Examples of these security factors may include (i) a user type, (ii) a clock time, (iii) an image type, (iv) a print medium type, (v) a user ID or user location, and (vi) a device ID or device location of hardware providing the user input to the MSSM module 122. The selected security label may be stored in the memory unit 104 by the MSSM module 122.

At 208, a predefined micro-symbol is selected and received based on the selected security label. In some configurations, the MSSM module 122 receives or fetches a predefined micro-symbol from the micro-symbol database in the memory unit 104 based on the selected security label. In some configurations, the MSSM module 122 selects the micro-symbol from a set of pre-stored micro-symbols in the micro-symbol database based on the received security label. The micro-symbol is received to create a security mark for the input image (or the print medium). The micro-symbol may define or include the security mark, or vice versa.

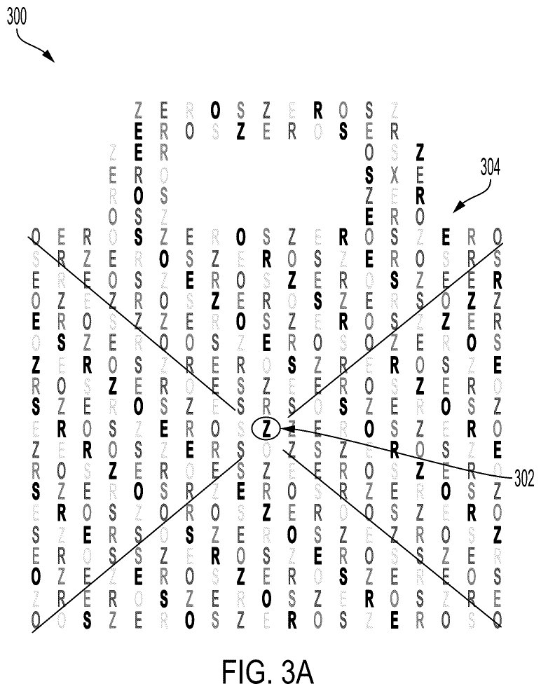

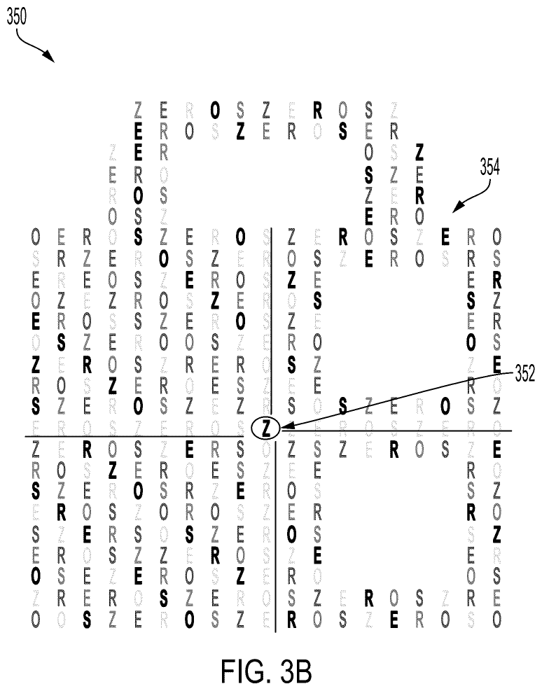

The micro-symbol has a first set of one or more predefined attributes. The micro-symbol includes microtext characters forming a predefined shape. The microtext characters, either individually or collectively, may have a second set of one or more attributes. Examples of the predefined attributes (in the first set and the second set) include microtext type (e.g., natural language, numeric, alphabetical, alphanumeric, etc.), color, shape, angle, and size. The first set of attributes may be different from the second set of attributes. In some configurations, the first set of attributes and the second set of attributes may have at least one attribute that is common, shared, or the same. In some configurations, the microtext characters include a principal character and one or more peripheral characters in a predefined natural language. The principal character and the peripheral characters collectively define the shape of the micro-symbol. For example, as illustrated in FIG. 3A, the micro-symbol 300 includes a principal character 302 and peripheral characters 304 in English language. The peripheral characters 304 may be arranged in a preset distance (e.g., distance ranging from 1 pixel to 15 pixels) and a preset direction from the principal character 302. The peripheral characters 304 in combination with the principal character 302 may define a preset shape such as a padlock shape of the micro-symbol 300. As illustrated, the principal character 302 includes a single microtext character such as a single microtext character ‘Z’ within a black-color circle. In some configurations, the principal character 302 has a group of the same or different types of microtext characters having a predefined sequence or attributes.

The principal character 302 may be located at a geometric center of a lower portion of the micro-symbol 300. Other examples may include the principal character 302 located in an upper portion or a portion lateral to the geometric center of the micro-symbol 300. In some configurations, the principal character 302 may be located at a corner or at an edge portion of the micro-symbol 300. In the vicinity of the principal character 302, the micro-symbol 300 may include the peripheral characters 304. For example, as illustrated in FIG. 3A, the micro-symbol 300 includes the peripheral characters 304, namely microtext characters, namely, ‘Z’, ‘E’, ‘R’, ‘O’ and ‘S’, in the proximity of the principal character 302. The peripheral characters 304 may be set in CMYK color space for the underlying microtext characters, namely, ‘Z’, ‘E’, ‘R’, ‘O’ and ‘S’ to have Cyan, Magenta, Yellow, Black and Cyan colors in a sequential manner. Some examples may include the peripheral characters 304 set in other types of color spaces.

In some configurations, the peripheral characters 304 include a set of peripheral characters having a predefined color along a preset direction or angle based on a selected security label. In one example, as illustrated in FIG. 3A, based on a security label “CONFIDENTIAL”, the micro-symbol 300 includes a set of peripheral characters (hereinafter also referred to as angled peripheral characters) in magenta color and arranged in set directions from the principal character 302. The angled peripheral characters arranged in magenta color are arranged along two character axes 306a and 306b indicated by solid black lines. The two-character axes 306a and 306b define directions with respect to the principal character 302. The character axes 306a and 306b pass through (or intersects at) the principal character 302. In some configurations, a first character axis 306a extends at an angle of 45 degrees from the principal character 302 and with respect to a horizontal axis. The second character axis 306b extends at an angle of 135 degrees from the principal character 302 and with respect to the same horizontal axis. The character axes 306a and 306b may have an angle of 90° between them. A set combination of the color and direction of the angled peripheral characters may represent or indicate the corresponding security label, namely “CONFIDENTIAL” selected by the MSSM module 122.

In some configurations, as illustrated in FIG. 3B, based on a security label “RESTRICTED”, a micro-symbol 350 may include a principal character 352 and peripheral characters 354 in the English language. The peripheral characters 354 may be arranged in a preset distance (e.g., distance ranging from 1 pixel to 15 pixels) from the principal character 352. The peripheral characters 354 in combination with the principal character 352 provides a holed-padlock shape to the micro-symbol 350. The micro-symbols, such as the micro-symbols 300 and 350, may have different shapes depending on the associated security label. The principal character 352 may include a single microtext character ‘Z’ within a black-color circle. The principal character 352 may be located at a geometric center of a lower portion (or larger portion) of the micro-symbol 350. In some configurations, the principal character 352 is located in an upper portion or a portion lateral to the geometric center of the micro-symbol 350.

The micro-symbol 350 includes the peripheral characters 354 set in CMYK color space in the vicinity of the principal character 352. In some configurations, for example in FIG. 3B, based on the security label “RESTRICTED”, the angled peripheral characters are set in yellow color along directions defined by character axes 356a and 356b indicated by solid black lines. The character axes 356a and 356b pass through (or intersect at) the principal character 352. In some configurations, the character axis 356a extends at an angle of 0° with respect to the horizontal axis and the character axis 356b extends at an angle of 90° with respect to the same horizontal axis. Accordingly, the character axes 356a and 356b are orthogonal to each other having an angle of 90° between them. A set combination of the color and direction of the angled peripheral characters represents or indicates the corresponding security label, namely “RESTRICTED” selected by the MSSM module 122. A predefined micro-symbol is received based on the selected security label.

At 210, an output image including the micro-symbol is generated. In some configurations, the MSSM module 122 is configured to generate an output image, e.g., for storage or sending to the output unit 108. The MSSM module 122 may place or encode the micro-symbol, which may be received based on the selected security label, at the selected location (or selected region) in the input image to generate the output image. The embedded micro-symbol, such as the micro-symbol 300 and micro-symbol 350, may represent a security mark for the output image (or the corresponding print medium). The security mark assists in (i) authenticating the output image and/or the print medium on which the output image may be printed, and (ii) performing or inhibiting a preset task based on the security label. The output image may be sent to the output unit 108 by the MSSM module 122. In some configurations, the MSSM module 122 stores the output image in the memory unit 104.

The output unit 108 may operate in communication with the image processing unit 106 via modules thereof over a wired or wireless connection. The output unit 108 receives the output image and related data from the MSSM module 122. In some configurations, the output unit 108 fetches the output image and related data from the memory unit 104. Examples of the output unit 108 may include a display device such as a touchscreen display, a handling device (such as a print head controller and a marking engine), a storage medium, a computing device, and a printer. In some configurations, the output unit 108 is configured to print the output image including the micro-symbol. In some configurations, the output unit 108 is configured to perform or inhibit (or sometimes even stop) a preset task based on the micro-symbol embedded with the received output image. Examples of the preset task may include (i) display, email, store, or print the output image on a print medium, (ii) display or send an email alert message on to a remote device, (iii) trigger sounds and lights on or from the corresponding devices operably connected to the output unit 108, (iv) prevent access to the output image, (v) record data including clock time, device ID, device location, and/or user of the system, and (vi) send the recorded data to the remote device.

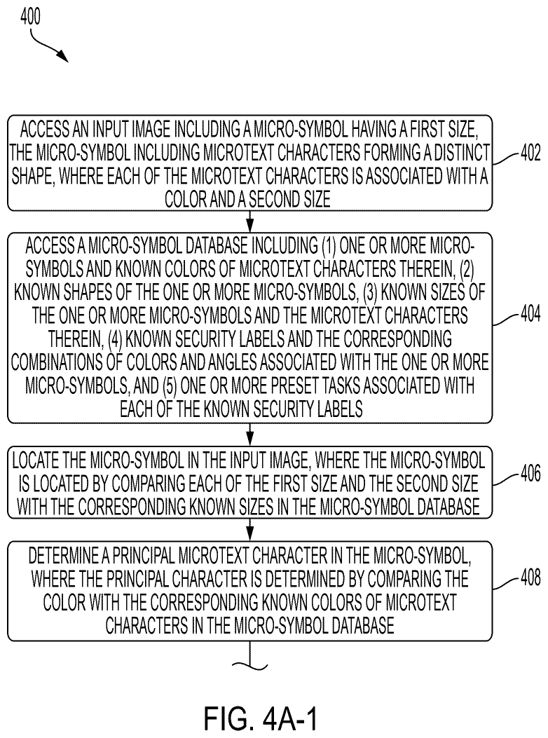

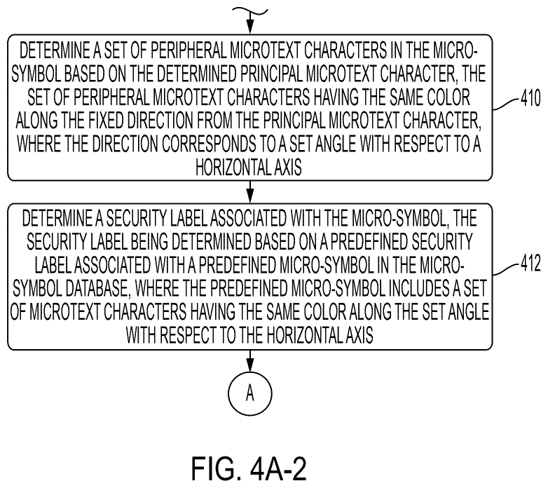

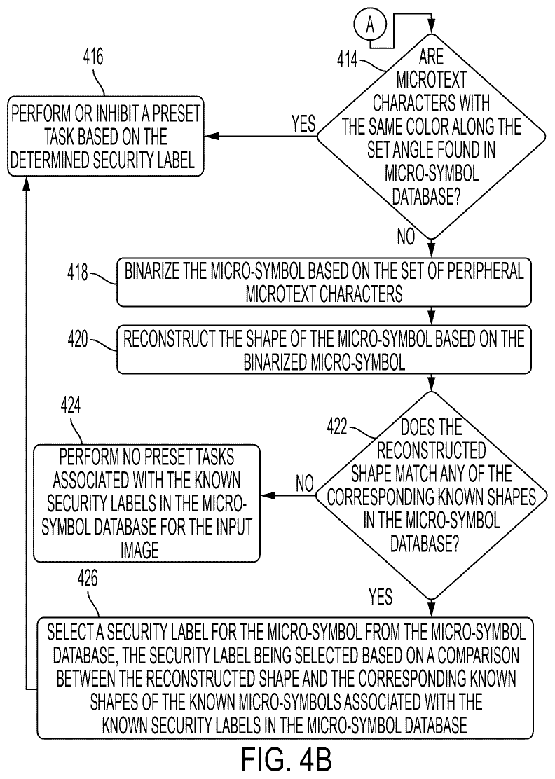

FIGS. 4A-4B are flowcharts illustrating a method 400 in accordance with embodiments of the present disclosure, for example, implemented by the MSSM module of FIG. 1, to verify and validate a micro-symbol embedded in an input image or document. In some configurations, the method 400 may be implemented by an image source 102, such as a multi-function device. The method 400 may be described in the general context of computer-executable instructions. The order in which the steps of the method 400 are described is not intended to be construed as a limitation, and the described method blocks may be combined or otherwise performed in any order to implement the method 400, or an alternate method. Individual blocks may be deleted from the method 400 without departing from the concepts described herein. The method 400 may be implemented in hardware, software, firmware, or combination thereof. The method 400 can be implemented on the image processing unit 106 or modules thereof such as the MSSM module 122. In some configurations, the method 400 may be implemented by a remote device such as the output unit 108. The method 400 may be modified for implementation with other configurations and methods without departing from the concepts described in the present disclosure.

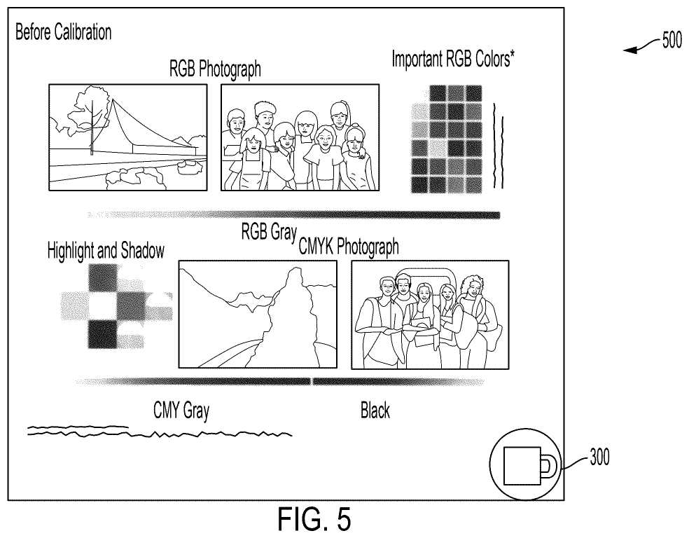

At 402, an input image including a micro-symbol is accessed. In some configurations, the MSSM module 122 (or the processor) may receive or access an input electronic image, such as an input image 500 (FIG. 5), from the image source 102. The input image, in some configurations, may be stored in the memory unit 104. In some configurations, the image source 102 can be a scanner or scanning device including a scanner such as an optical scanner which scans a physical document to generate the input image and related data. The input image may be generated in a color space such as grayscale, RGB, and CMYK. In some configurations, the input image, such as the input image 500 may be set in RGB color space. The input image includes a micro-symbol, such as the micro-symbol 300, having a first size. The micro-symbol includes microtext characters forming a distinct shape of the micro-symbol. The microtext characters are associated with colors and have a second size. The microtext characters include a principal character, such as the principal character 302, and one or more peripheral characters such as the peripheral characters 304. In some configurations, the principal character may have a color different from that of the peripheral characters in the micro-symbol.

At 404, a micro-symbol database is accessed. In some configurations, the MSSM module 122 accesses a micro-symbol database stored in the memory unit 104. The micro-symbol database may include (1) one or more predetermined micro-symbols and other colors of microtext characters in the micro-symbols, (2) shapes of these micro-symbols, (3) sizes of these micro-symbols as well as sizes of the individual microtext characters in the micro-symbols, (4) principal character and peripheral characters in the micro-symbols, (5) color of the principal character and the peripheral characters, (6) color of a set of the peripheral characters (angled peripheral characters) where the set of peripheral characters have a uniform color along a pre-defined direction and known angle that the set of the peripheral characters form with the horizontal axis, (7) security labels and the micro-symbols associated therewith, where the security label may be associated with the shape of the micro-symbol and combinations of colors and angles (of the set of the peripheral characters) in the corresponding micro-symbol, and (8) one or more tasks associated with the security labels.

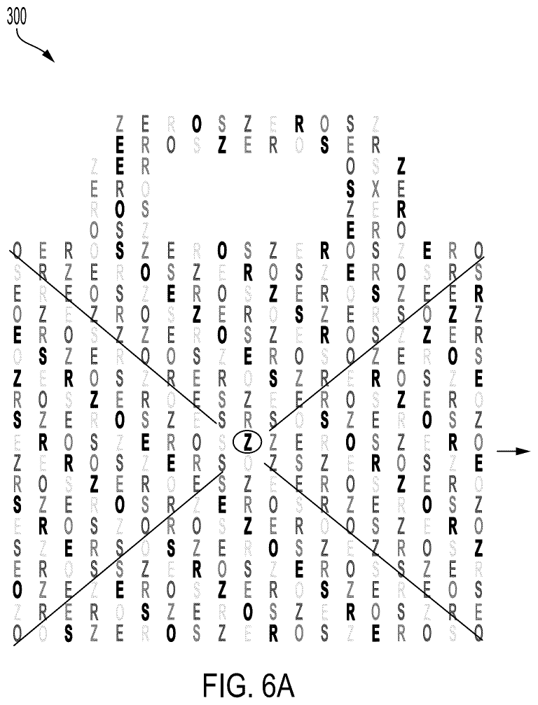

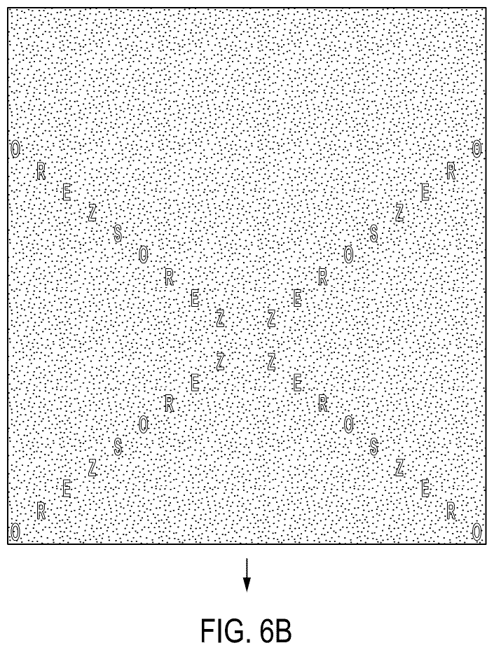

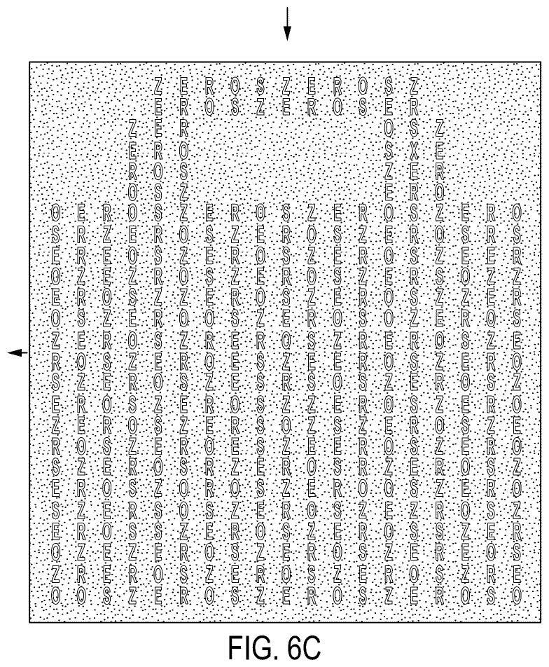

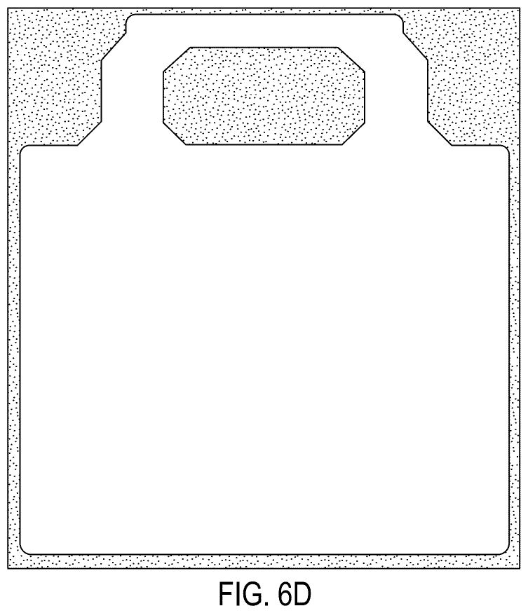

At 406, the micro-symbol in the input image is located. In some configurations, the MSSM module 122 scans the input image such as the input image to locate or recognize the micro-symbol such as the micro-symbol 300 embedded therein. In some configurations, the MSSM module 122 may compare the first size of the micro-symbol 300 with the corresponding micro-symbol sizes stored in the micro-symbol database. The MSSM module 122 may compare the second size of the microtext characters in the micro-symbol 300 with the sizes of microtext characters in the micro-symbol database. Other examples may include the MSSM module 122 comparing a shape of the micro-symbol with predefined shapes in the micro-symbol database. Based on the comparison, the MSSM module 122 may determine or locate the micro-symbol in the input image. In some configurations, the MSSM module 122 processes one or more locations in the document, where the micro-symbol can be located and determines the presence of the micro-symbol in the one or more pre-defined locations. In some configurations, as illustrated in FIG. 5, the MSSM module 122 may determine the micro-symbol 300 to be located in the top-right region near a corner of the input image 500 in a portrait mode based on the comparison. FIG. 6A illustrates a snapshot 600 of a zoomed-in version of the micro-symbol 300 extracted from the input image 500 of FIG. 5.

At 408, a principal character in the micro-symbol is determined. In some configurations, the MSSM module 122 determines a principal character in the determined micro-symbol in the input image. In some configurations, the MSSM module 122 is configured to determine a principal character 302 in the micro-symbol 300 by comparing the color of the microtext characters with the known colors of microtext characters, specifically the known color of the principal character, in the micro-symbol database. Based on the comparison, the MSSM module 122 may determine the principal character 302 within the micro-symbol 300. In some configurations, the principal character 302 may be located at a geometric center of a larger portion (or a lower portion) of the micro-symbol 300, and the MSSM module 122 locates the character positioned at the geometric center of the micro-symbol and accordingly determines the principal character. In some configurations, the principal character is located at a pre-defined/known location in the micro-symbol and using the known location, the MSSM module 122 determines the principal character. The principal character and its location in the micro-symbol are determined.

At 410, a set of peripheral characters in the micro-symbol is determined. In some configurations, the MSSM module 122 determines a set of peripheral characters in the micro-symbol such as the micro-symbol 300 in the input image such as the input image 500. The set of peripheral characters have the same/uniform color along a pre-defined direction with respect to the previously determined principal character. In some configurations, to determine the set of peripheral characters, the MSSM module 122 checks for presence of uniform colors, specifically, one or more pre-defined colors (uniform color characters), in pre-defined directions. The one or more pre-defined colors and the pre-defined directions are determined based on the known color and angle associated with the set of peripheral characters in the pre-stored micro-symbols. For example, if the micro-symbol database includes four different micro-symbols including a pre-defined micro-symbol with a set of cyan colored peripheral characters at 45°, a pre-defined micro-symbol with a set of magenta colored peripheral characters at 60°, a pre-defined micro-symbol with a set of yellow colored peripheral characters at 75°, and a pre-defined micro-symbol with a set of black colored peripheral characters at 90°. The MSSM module 122 checks in the four directions to identify the presence of the uniform color characters. The direction for the peripheral characters may correspond to an angle with respect to a horizontal axis, such as the x-axis, passing through the principal character. The MSSM module 122 may determine the presence of the set of the peripheral characters, associated angle and the color. In some configurations, the MSSM module 122 applies a filter or a combination of filters to determine the presence of the set of peripheral characters. FIG. 6B illustrates a snapshot 610 of a filtered image 612 including a set of peripheral characters 614. When the MSSM module 122 applies a filter or a combination of filters on the image, the MSSM module 122 generates the filtered image 612 including the set of the microtext characters. The MSSM module 122 determines the presence of the set of the peripheral characters having uniform color along one of the possible pre-defined directions and thus the direction or angle of the set of the peripheral characters. The MSSM module 122 determines the color of the set of microtext characters.

At 412, the MSSM module 122 compares the angle and the color of the set of peripheral characters in the micro-symbol with the angle and the color of the pre-stored micro-symbols. The MSSM module 122 is configured to check whether the combinations of color and angle associated with the set of peripheral characters match with the color and angle associated with the pre-stored micro-symbols. Based on the comparison, the MSSM module 122 performs further processing. In some configurations, upon unsuccessful match, the processing of the micro-symbol and/or the input image is reinitiated. In some configurations, upon unsuccessful match, the processing of the micro-symbol and/or the input image is aborted and a user such as an admin user is notified.

Upon successful match, at 414, shape of the micro-symbol is further validated. In some configurations, the MSSM module 122 is configured to validate the shape of the micro-symbol. The MSSM module 122 may be configured to binarize 418 the micro-symbol such as the micro-symbol 300 and reconstruct 420 the shape of the micro-symbol based on the binarized micro-symbol. During binarization, the MSSM module 122 converts the micro-symbol into a binary image, where the pixels of the binary image may have one of two values, for example, zero representing black color and 1 representing white color. FIG. 6C, illustrates a snapshot 620 of a micro-symbol 622 obtained after the binarization. When the MSSM module 122 binarizes the micro-symbol 300 of FIG. 6A, the MSSM module 122 generates the binarized micro-symbol 622. The binarization process may involve setting a threshold value, and then converting the pixel's intensity value to either white or black based on whether its intensity is above or below the threshold. The MSSM module 122 generates the binarized micro-symbol.

The MSSM module 122 reconstructs the shape of the binarized micro-symbol. In some configurations, the MSSM module 122 may implement a pixel shifting algorithm on the binary image to create a reconstructed/modified binary image. FIG. 6D illustrates a snapshot 630 of a reconstructed micro-symbol 632. When the MSSM module 122 performs the pixel reconstruction operation on the binarized micro-symbol 622 of FIG. 6C, the MSSM module 122 generates the reconstructed micro-symbol 632. The reconstructed shape may assist in validating the micro-symbol. Once reconstructed, the MSSM module 122 is configured to check 422 whether the reconstructed shape matches with any known shapes in the micro-symbol database. Based on the comparison, the shape of the micro-symbol is validated. In some configurations, the MSSM module 122 uses the shape associated with the pre-stored micro-symbol with which the color and the angle of the set of peripheral characters match for comparison. For example, if the color and angle of the set of peripheral characters match with the color and angle associated with a pre-stored micro-symbol, for example, a third micro-symbol, then the shape of the reconstructed micro-symbol is also compared with the shape of the third micro-symbol. The MSSM module 122 compares the shape of the reconstructed micro-symbol with the shapes of the pre-stored micro-symbols and performs the validation. In some configurations, upon successful match, the micro-symbol is validated.

At 416, based on the validation, a task is performed 416 or prohibited 424 based on the determined security label. In some configurations, upon successful validation of the micro-symbol, a security label associated with the micro-symbol is determined 426 using the micro-symbol database, which assists in determining the one or more tasks (e.g., send an alert message) associated with the selected security label (or the associated micro-symbol). In some configurations, upon determination of the security label, say “CONFIDENTIAL”, the MSSM module 122 may inhibit a job request (e.g., print job triggered by a user, display, etc.) for the input image and perform another task (e.g., send an alert message) associated with the selected security label (or the associated micro-symbol). In some configurations, upon unsuccessful validation of the micro-symbol, the processing of the micro-symbol is reinitiated. In some configurations, upon unsuccessful validation of the micro-symbol, the processing of the input image is aborted and an admin user is notified.

In an aspect, a computer-implemented method for implementing a security mark, comprising: receiving, using a processor, an input image of a document, wherein the input image comprises a region that may not include content; receiving, using the processor, a predefined security label for the input image; selecting, using the processor, a micro-symbol based on the received security label, the micro-symbol comprising microtext characters having a principal character and a set of peripheral characters, wherein the set of peripheral characters has the same color along a set direction from the principal character; and generating, using the processor, an output image based on the selected micro-symbol, the output image including the selected micro-symbol embedded in the region, wherein the micro-symbol represents a security mark pertaining to a preset task.

In an aspect, a computer-implemented method wherein the set direction corresponds to an angle with respect to a horizontal axis passing through the principal character, wherein the angle is based on the received security label.

In an aspect, a computer-implemented method wherein the principal character has a first color and the set of peripheral characters has a second color different from the first color.

In an aspect, a computer-implemented method wherein the microtext characters define a preset shape of the micro-symbol based on the received security label.

In an aspect, a computer-implemented method further comprising: performing or inhibiting, using the processor, the preset task based on the security label or the micro-symbol.

In an aspect, a system for implementing a security mark, comprising: an image source configured to provide an input image of a document; and a processor operating in communication with the image source, wherein the processor is configured to: receive the input image, wherein the input image comprises a region that may not include content; receive a predefined security label for the input image; select a micro-symbol based on the received security label, the micro-symbol comprising microtext characters having a principal character and a set of peripheral characters, wherein the peripheral characters in the set have the same color along a set direction from the principal character; and generate an output image based on the selected micro-symbol, the output image including the selected micro-symbol embedded in the region, wherein the micro-symbol represents a security mark pertaining to a preset task.

In an aspect, the system wherein the set direction corresponds to an angle with respect to a horizontal axis passing through the principal character, wherein the angle is based on the received security label.

In an aspect, the system wherein the principal character has a first color and the set of peripheral characters has a second color different from the first color.

In an aspect, the system wherein the microtext characters define a preset shape of the micro-symbol.

In an aspect, the system wherein the processor is further configured to perform or inhibit the preset task based on the security label or the micro-symbol.

In an aspect, a computer-implemented method for configuring an image processing unit to control a preset task, the computer-implemented method comprising: receiving, using a processor, an input image comprising a micro-symbol representing a security mark, wherein the micro-symbol comprises microtext characters defining a shape of the micro-symbol; determining, using the processing, a principal character in the microtext characters; determining, using the processing, a set of peripheral characters in the microtext characters based on the principal character, the set being determined based on the peripheral characters therein having the same color along a fixed direction from the principal character, wherein the fixed direction corresponds to a set angle with respect to a horizontal axis; comparing the color and the angle associated with the set of peripheral characters with a color and an angle associated with one or more pre-stored micro-symbols; upon successful comparison, determining, using the processing, a security label associated with the micro-symbol; and inhibiting, using the processing, a preset task for the input image based on the determined security label.

In an aspect, the computer-implemented method further comprising validating a shape of the micro-symbol.

In an aspect, the computer-implemented method wherein the security label is identified based on a predefined security label associated with the pre-stored micro-symbol having the same color and angle associated with a set of peripheral characters and/or having the same shape of the micro-symbol.

In an aspect, the computer-implemented method wherein validating the shape of the micro-symbol comprises: binarizing, using the processing, the micro-symbol to create a binarized micro-symbol; reconstructing, using the processing, portions of the binarized micro-symbol to create a reconstructed micro-symbol; comparing the reconstructed micro-symbol with one or more pre-stored micro-symbols; and based on the comparison validating the shape of the micro-symbol. In an aspect, the computer-implemented method further comprising locating, using the processor, the micro-symbol in the input image based on at least one of the shape of the micro-symbol and a size of the microtext characters therein.

In an aspect, a system for configuring an image processing device to control a preset task, the system comprising: an image source configured to provide an input image comprising a micro-symbol representing a security mark, wherein the micro-symbol further comprises microtext characters defining a shape of the micro-symbol; and a processor operating in communication with the image source, wherein the processor is configured to: receive the input image comprising the micro-symbol; determine a principal character in the microtext characters of the micro-symbol; determine a set of peripheral characters in the microtext characters based on the principal character, the set being determined based on the peripheral characters therein having the same color along a fixed direction from the principal character, wherein the fixed direction corresponds to a set angle with respect to a horizontal axis; compare the color and the angle associated with the set of peripheral characters with a color and an angle associated with one or more pre-stored micro-symbols; upon successful comparison, determine a security label associated with the micro-symbol; and inhibit a preset task for the input image based on the determined security label.

In an aspect, the system wherein the processor is further configured to validate a shape of the micro-symbol.

In an aspect, the system wherein the processor is further configured to identify the security label based on a predefined security label associated with the pre-stored micro-symbol having the same color and angle associated with a set of peripheral characters and/or having the same shape of the micro-symbol.

In an aspect, the system wherein to validate the shape of the micro-symbol the processor is configured to: binarize the micro-symbol to create a binarized micro-symbol; reconstruct portions of the binarized micro-symbol to create a reconstructed micro-symbol; compare the reconstructed micro-symbol with one or more pre-stored micro-symbols; and based on the comparison validate the shape of the micro-symbol.

In an aspect, the system wherein the processor is further configured to locate the micro-symbol in the input image based on at least one of the shape of the micro-symbol and a size of the microtext characters therein.

Note that throughout the description herein, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Unless specifically stated otherwise, as apparent from the discussion herein, it is appreciated that throughout the description, discussions utilizing terms such as “receiving” or “determining” or “identifying” “or accumulating” or “comparing” or “storing” or “selecting” or “setting” or “changing” or “updating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

A computer program used to implement systems and methods in accordance with embodiments of the present disclosure may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or media for storing electronic instructions.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

The terminology used herein is not intended to be limiting of the disclosure. It will be appreciated that the features and functions disclosued herein, or alternatives thereof, may be combined into other systems or applications. Various presently unforeseen or unanticipated alternatives, modifications, variations, or improvements therein may be made without departing from the scope of the present disclosure.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A computer-implemented method for implementing a security mark, comprising:
receiving, using a processor, an input image of a document, wherein the input image comprises a region with no content;
receiving, using the processor, a security label for the input image;
selecting, using the processor, a micro-symbol based on the received security label, the micro-symbol comprising microtext characters having a principal character and a set of peripheral characters, wherein the set of peripheral characters has a same color along a set direction from the principal character; and
generating, using the processor, an output image based on the selected micro-symbol, the output image including the selected micro-symbol embedded in the region, wherein the micro-symbol represents a security mark pertaining to a preset task.

2. The computer-implemented method of claim 1, wherein the set direction corresponds to an angle with respect to a horizontal axis passing through the principal character, wherein the angle is based on the received security label.

3. The computer-implemented method of claim 1, wherein the principal character has a first color and the set of peripheral characters has a second color different from the first color.

4. The computer-implemented method of claim 1, wherein the microtext characters define a preset shape of the micro-symbol based on the received security label.

5. The computer-implemented method of claim 1, further comprising:
performing or inhibiting, using the processor, the preset task based on the security label or the micro-symbol.

6. The computer-implemented method of claim 1, further comprising:
determining, using the processor, the principal character in the microtext characters;
determining, using the processor, the security label associated with the micro-symbol when the color and an angle associated with the set of peripheral characters are the same as a color and an angle associated with one or more pre-stored micro-symbols; and
inhibiting, using the processor, the preset task for the input image based on the determined security label.

7. The computer-implemented method of claim 6, wherein the determined security label is identified based on a predefined security label associated with the pre-stored micro-symbol having the same color and the angle associated with the set of peripheral characters or having a same shape of the micro-symbol.

8. The computer-implemented method of claim 1, further comprising:
validating, using the processor, a shape of the micro-symbol.

9. The computer-implemented method of claim 8, wherein validating the shape of the micro-symbol comprises:
binarizing, using the processor, the micro-symbol to create a binarized micro-symbol;
reconstructing, using the processor, portions of the binarized micro-symbol to create a reconstructed micro-symbol; and
validating the shape of the micro-symbol based on a comparison of the reconstructed micro-symbol with one or more pre-stored micro-symbols.

10. The computer-implemented method of claim 6, further comprising:
locating, using the processor, the micro-symbol in the input image based on at least one of a shape of the micro-symbol and a size of the microtext characters therein.

11. A system for implementing a security mark, comprising:
an image source configured to provide an input image of a document; and
a processor operating in communication with the image source, wherein the processor is configured to:
receive the input image, wherein the input image comprises a region with no content;
receive a predefined security label for the input image;
select a micro-symbol based on the received security label, the micro-symbol comprising microtext characters having a principal character and a set of peripheral characters, wherein the peripheral characters in the set have a same color along a set direction from the principal character; and
generate an output image based on the selected micro-symbol, the output image including the selected micro-symbol embedded in the region, wherein the micro-symbol represents a security mark pertaining to a preset task.

12. The system of claim 11, wherein the set direction corresponds to an angle with respect to a horizontal axis passing through the principal character, wherein the angle is based on the received security label.

13. The system of claim 11, wherein the principal character has a first color and the set of peripheral characters has a second color different from the first color.

14. The system of claim 11, wherein the microtext characters define a preset shape of the micro-symbol.

15. The system of claim 11, wherein the processor is further configured to perform or inhibit the preset task based on the security label or the micro-symbol.

16. A computer program product for implementing a security mark, the computer program product comprising a computer-readable storage medium having program instructions embodied therewith, the program instructions executable by a computing device to cause the computing device to perform operations comprising:
receiving an input image comprising a micro-symbol representing a security mark, wherein the micro-symbol further comprises microtext characters defining a shape of the micro-symbol;
determining a principal character in the microtext characters of the micro-symbol;
determining a set of peripheral characters in the microtext characters based on the principal character, the set being determined based on the peripheral characters therein having a same color along a fixed direction from the principal character, wherein the fixed direction corresponds to a set angle with respect to a horizontal axis;
comparing the color and the angle associated with the set of peripheral characters with a color and an angle associated with one or more pre-stored micro-symbols;
upon successful comparison, determining a security label associated with the micro-symbol; and
inhibiting a preset task for the input image based on the determined security label.

17. The computer program product of claim 16, further configuring:
validating a shape of the micro-symbol.

18. The computer program product of claim 17, further comprising:
identifying the security label based on a predefined security label associated with the pre-stored micro-symbol having the same color and angle associated with he set of peripheral characters or having a same shape of the micro-symbol.

19. The computer program product of claim 17, wherein validating the shape of the micro-symbol comprises:
binarizing the micro-symbol to create a binarized micro-symbol;
reconstructing portions of the binarized micro-symbol to create a reconstructed micro-symbol;
comparing the reconstructed micro-symbol with one or more pre-stored micro-symbols; and
based on the comparison, validating the shape of the micro-symbol.

20. The computer program product of claim 16, wherein the processor is further configured to locate the micro-symbol in the input image based on at least one of the shape of the micro-symbol and a size of the microtext characters therein.
